(19) United States
(12) Patent Application Publication
(10) Pub. No.: US 2010/0203479 A1
(43) Pub. Date: Aug. 12, 2010

(54) DENTAL IMPLANT SYSTEM AND METHODS

(76) Inventors: Scott E. Bulloch, St. George, UT (US); Russell G. Olsen, Cedar City, UT (US)

Correspondence Address: Kunzler Needham Massey & Thorpe, 8 EAST BROADWAY, SUITE 600, SALT LAKE CITY, UT, 84111, US

(21) Appl. No.: 12/367,381

(22) Filed: Feb. 6, 2009

(51) Int. Cl. A61C 1/00

(52) U.S. Cl. 433/215; 433/75

(57) ABSTRACT

According to one embodiment, a cannulated dental implant system for implanting a dental implant in bone tissue includes a guide splint having at least one guide sleeve defining a guide channel. The system also includes a guide pin with a bone penetrating end portion. The guide pin is extendable through the guide channel and drivable into bone tissue. Further, the system includes a first drill bit with a first outer diameter and an axial channel sized to receive the guide pin. The first drill bit is rotatable about the guide pin to drill a hole into the bone tissue. The hole has a diameter corresponding with the first outer diameter. The system includes a second drill bit with a second outer diameter that is greater than the first outer diameter. The second drill bit further includes an axial channel sized to receive the guide pin. Moreover, the second drill bit is rotatable about the guide pin to enlarge the hole in the bone tissue to correspond with the second outer diameter. Additionally, the system includes a dental implant securable within the enlarged hole.

### FIELD

This invention relates to dental implants and more particularly to a dental implant system for placing and installing dental implants.

### BACKGROUND

Practitioners, such as dentists or oral surgeons, use various techniques and devices for placing and installing dental implants or other prosthetics in a patient's mouth. Generally, dental implants are placed and installed using non-cannulated drilling techniques for drilling a hole into the jaw bone of the patient and securely positioning the dental implant within the formed hole. The size, shape, and orientation of the formed holes are important because the holes typically dictate the fit and orientation of the dental implant.

Conventional hole forming techniques in dental applications include accessing the portion of the jawbone where the dental implant will be placed by creating incisions in the patient's gums. The practitioner then pushes each flap of gum tissue back to expose the underlying bone. Generally, once the bone is exposed, the practitioner uses a series of incrementally larger diameter drill bits (also commonly referred to as “drills”) to prepare the hole into which the implant is placed. More specifically, according to several known techniques, a drill guide splint is formed from a cast of the patient's mouth and placed in the patient's mouth. The drill guide splint is used to direct round burs and/or bone drill bits in place during drilling. A small round bur or drill bit is first used to form a divot in the bone. A pilot drill bit is then used to form a pilot hole in the bone for positioning larger drill bits.

After the pilot hole is formed, the practitioner evaluates the positioning, orientation and angle of the implant hole by inserting an alignment pin into the implant hole. If the alignment is correct, the practitioner uses the pilot drill bit to drill the total depth needed for the implant. The practitioner incrementally expands the hole to a final size by utilizing several drill bits of increasing diameter. The dental implant is then placed in and secured to the formed hole.

In contrast to dental applications, the use of cannulated drill systems for forming holes in non-dental human tissue is known in the art. Although some cannulated drill systems have been used to form holes in human tissue, such systems are not adapted for use in dental applications.

### SUMMARY

The subject matter of the present application has been developed in response to the present state of the art, and in particular, in response to the problems and needs in the art that have not yet been fully solved by currently available dental implant placement and installation techniques. Accordingly, the subject matter of the present application has been developed to provide a dental implant system and associated methods that overcomes at least some of the shortcomings of the prior art.

There are several shortcomings associated with currently available dental implant placement and installation systems. First, accurate placement and orientation of the round bur and pilot drill bit on the patient's bone can be difficult. Not only must the pilot hole be oriented in a correct position, but it must also be oriented at a correct angle. Currently available systems do not provide for consistent placement and orientation of dental implant holes.

Second, once a pilot hole has been formed, relocating the hole is very difficult. Accordingly, if the divot or pilot hole is initially formed in the wrong position, a new divot and pilot hole must be drilled and the old hole is wasted. Further, due to the size of the pilot drill bit, significant damage to the bone and overlying soft tissue may occur, which can make repositioning of a new hole difficult.

Third, with conventional systems, there is a risk that the drill will contact the guide splint as the drills cuts. If the drill contacts the guide splint, pieces of the guide splint may be removed from the guide splint and become lodged in the surgical site.

Finally, after the pilot drill bit is removed, conventional systems do not include a mechanism for directionally guiding the subsequent larger drill bits. Directional guidance is provided only by positioning the larger drill bits over the previously drilled hole. The larger drill bits often vary from the orientation of the previously drilled path. This can be problematic for dental applications where bone angles or slopes necessitate accurately positioned and oriented holes as only slight variances can severely damage the patient's bone.

Described herein are several embodiments of a dental implant drilling system that overcomes one or more of the shortcomings of prior art systems. For example, in some implementations, the dental implant system provides improved directional guidance and low impact drilling such that the initial positioning of the hole can be redone if necessary. Further, in some implementations, the dental implant system promotes improved transfer of information obtained in laboratory settings to actual surgery to facilitate more accurate drilling techniques. Some dental implant systems described herein reduce the risk of fragments being removed from the guide splint and contaminating the surgical site. Further, in some embodiments, the speed of implanting and accuracy of the implants can be improved. Additionally, various embodiments of the dental implant systems described herein provide directional information and guidance after the pilot hole is formed by the pilot drill bit.

According to one embodiment, a cannulated dental implant system for implanting a dental implant in bone tissue includes a guide splint having at least one guide sleeve defining a guide channel. The system also includes a guide pin with a bone penetrating end portion. The guide pin is extendable through the guide channel and drivable into bone tissue. In some implementations, the guide pin includes a series of markings indicating a depth of the guide pin in the bone tissue. Further, the system includes a first drill bit with a first outer diameter and an axial channel sized to receive the guide pin. The first drill bit is rotatable about the guide pin to drill a hole into the bone tissue. The hole has a diameter corresponding with the first outer diameter. The system includes a second drill bit with a second outer diameter that is greater than the first outer diameter. The second drill bit further includes an axial channel sized to receive the guide pin. Moreover, the second drill bit is rotatable about the guide pin to enlarge the hole in the bone tissue to correspond with the second outer diameter. Additionally, the system includes a dental implant securable within the enlarged hole.

In some implementations, the guide splint includes a plurality of guide sleeves. At least two of the plurality of guide sleeves can be oriented at different angles with respect to each other. In certain implementations, the at least one guide sleeve is removably secured to the guide splint. The at least one guide sleeve can be positioned within a hole formed in the guide splint.

According to yet some implementations, the guide splint can include at least two separable interconnected portions. The at least two separable interconnected portions are separable along a cut coextensive with a line extending through at least one of the guide sleeves. The two separable interconnected portions can include at least first and second portions. The first portion can include at least one first engagement element and the second portion can include at least one second engagement element corresponding with the first engagement element. The first and second engagement elements can be engageable to couple the first and second portions together and disengageable to separate the first and second portions from each other. The first engagement element can include an at least partially circular element and the second engagement element comprises an at least partially flexible socket configured to removably retain the at least partially circular element.

In some implementations, the system further includes a drilling assembly that includes a guide splint orientation adjustment stand removably coupled to a drill press. The drill press can include a first mating feature. The guide splint orientation adjustment stand can include a second mating feature matingly engageable with the first mating feature to removably secure the guide splint orientation adjustment stand in a desired position relative to the drill press. The guide splint orientation adjustment stand can be pivotable to orient a guide splint secured to the orientation adjustment stand in any of an infinite number of 3-dimensional orientations.

According to another embodiment, a method for implanting dental implants in bone tissue includes making a dental splint that includes at least one sleeve at a location corresponding with a desired implant location and positioning the dental splint over a set of teeth. The method further includes driving a guide pin through the at least one sleeve and into bone tissue and removing the dental splint from the set of teeth. Additionally, the method includes engaging a first drill bit with the guide pin and drilling a hole in the bone tissue with the first drill bit while engaged with the guide pin, as well as engaging a second drill bit with the guide pin and expanding the hole in the bone tissue with the second drill bit while engaged with the guide pin. The method also includes removing the guide pin from the bone tissue and positioning a dental implant in the expanded hole in the bone tissue.

In some implementations of the method, removing the dental splint from the set of teeth includes separating the dental splint into at least two pieces and individually removing the two pieces from the set of teeth. Separating the dental splint into at least two pieces can include disengaging corresponding engagement elements each coupled to a respective one of the two pieces.

According to yet some implementations, removing the dental splint from the set of teeth includes removing the at least one sleeve from the guide splint then removing the dental splint without the at least one sleeve from the set of teeth. In yet certain implementations, making the dental splint includes drilling a hole in the splint and positioning the at least one sleeve in the splint hole.

In some implementations, the method includes making a cast of the set of teeth, drilling at least one hole in the cast at the location corresponding with the desired implant location, positioning a radiopaque marker in the at least one hole, and forming the dental splint over the cast and radiopaque marker where the radiopaque marker is secured within the dental splint. The method can also include placing the dental splint with radiopaque marker over the set of teeth and imaging the dental splint and set of teeth and comparing the location and orientation of the radiopaque marker with a desired location and orientation of the dental implant. The method can include drilling a hole in the splint based on the comparison between the location and orientation of the radiopaque marker and the desired location and orientation of the dental implant. The dental splint can include a plurality of sleeves and driving a guide pin can include driving a plurality of drive pins through respective sleeves of the plurality of sleeves.

In another embodiment, a dental implant system for implanting a dental implant in bone tissue includes a plurality of guide sleeves each defining a differently sized guide channel, a guide splint positionable over a set of teeth where the guide splint includes a hole configured to individually receive each of the plurality of guide sleeves, and a plurality of drill bits each differently sized to correspond with a respective one of the differently sized guide channels of the plurality of guide sleeves. Each of the plurality of drill bits is configured to extend through the corresponding respective guide channel to form a hole in bone tissue.

According to yet another embodiment, a method for implanting dental implants in bone tissue includes making a dental splint comprising a hole at a location corresponding with a desired implant location and in an orientation corresponding with a desired implant orientation. The hole is formed using a medical imaging process. The method further includes positioning the dental splint over a set of teeth. Also, the method includes inserting a first guide sleeve defining a first guide channel having a first dimension into the dental splint hole. Additionally, the method includes extending a first drill bit having a first outer diameter corresponding with the first dimension through the first guide channel of the first guide sleeve and drilling a first hole in the bone tissue. The first hole has a size corresponding with the first outer diameter. Further, the method includes removing the first guide sleeve from the dental splint hole and inserting a second guide sleeve defining a second guide channel having a second dimension into the dental splint hole. The second dimension is larger than the first dimension. The method also includes extending a second drill bit having a second outer diameter corresponding with the second dimension through the second guide channel of the second guide sleeve and drilling a second hole in the bone tissue in place of the first hole. The second hole has a size corresponding with the second outer diameter. The method further includes removing the dental splint from the set of teeth and positioning a dental implant in the second hole.

Reference throughout this specification to features, advantages, or similar language does not imply that all of the features and advantages that may be realized with the subject matter of the present disclosure should be or are in any single embodiment. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

Furthermore, the described features, advantages, and characteristics of the subject matter of the present disclosure may be combined in any suitable manner in one or more embodiments. One skilled in the relevant art will recognize that the subject matter may be practiced without one or more of the specific features or advantages of a particular embodiment. In other instances, additional features and advantages may be recognized in certain embodiments that may not be present in all embodiments. These features and advantages will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 is a top plan view of a guide splint of a dental implant system according to one embodiment;

FIG. 2 is a side elevation view of the guide splint of FIG. 1 showing a guide sleeve in more detail;

FIG. 3A is a top plan view of a guide splint of a dental implant system according to another embodiment;

FIG. 3B is a side elevation view of the guide splint of FIG. 3A;

FIG. 4 is an exploded top plan view of the guide splint of FIG. 3A;

FIG. 5 is a side elevation view of a guide pin and pin driving device of a dental implant system according to one embodiment;

FIG. 6A is side elevation view of a bone penetrating end portion of a guide pin according to one embodiment;

FIG. 6B is a side elevation view of a bone penetrating end portion of a guide pin according to another embodiment;

FIG. 7A is a side elevation view of a cannulated drill bit of a small size engaged with a guide pin according to one embodiment;

FIG. 7B is a side elevation view of a cannulated drill bit of a medium size engaged with the guide pin according to one embodiment;

FIG. 7C is a side elevation view of a cannulated drill bit of a large size engaged with the guide pin according to one embodiment;

FIG. 8 is a side elevation view of a drilling assembly according to one embodiment;

FIG. 9 is a flow chart diagram illustrating a method for forming a guide splint according to one embodiment;

FIG. 10 is a subroutine of the method of FIG. 9 depicting actions associated with forming a separable guide splint;

FIG. 11 is a flow chart diagram illustrating a method for implanting one or more dental implants according to one embodiment; and

FIG. 12 is a subroutine of the method of FIG. 11 depicting actions associated with a cannulated technique according to one embodiment.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

Furthermore, the details, including the features, structures, or characteristics, of the subject matter described herein may be combined in any suitable manner in one or more embodiments. One skilled in the relevant art will recognize, however, that the subject matter may be practiced without one or more of the specific details, or with other methods, components, materials, and so forth. In other instances, well-known structures, materials, or operations are not shown or described in detail to avoid obscuring aspects of the disclosed subject matter.

Generally, described herein are embodiments of a cannulated dental implant system and associated methods. In one embodiment, the dental implant system includes a guide splint, a guide wire, and a series of cannulated drill bits each of a different size. The guide splint is formed using a guide splint formation device and includes a guide sleeve with a guide channel for receiving, positioning, and orienting the guide wire. With the guide splint in place within a patient's mouth, the guide wire is driven into the patient's bone at a desired location using the guide splint. The guide splint is removed leaving the guide wire in place. The cannulated drill bits are then individually and consecutively placed over the guide wire and actuated to incrementally form a hole of a desired size in the bone. In an alternative embodiment, instead of a guide wire and a series of cannulated drill bits, a series of variably sized guide sleeves in conjunction with variably sized drill bits are used to form the hole in the bone.

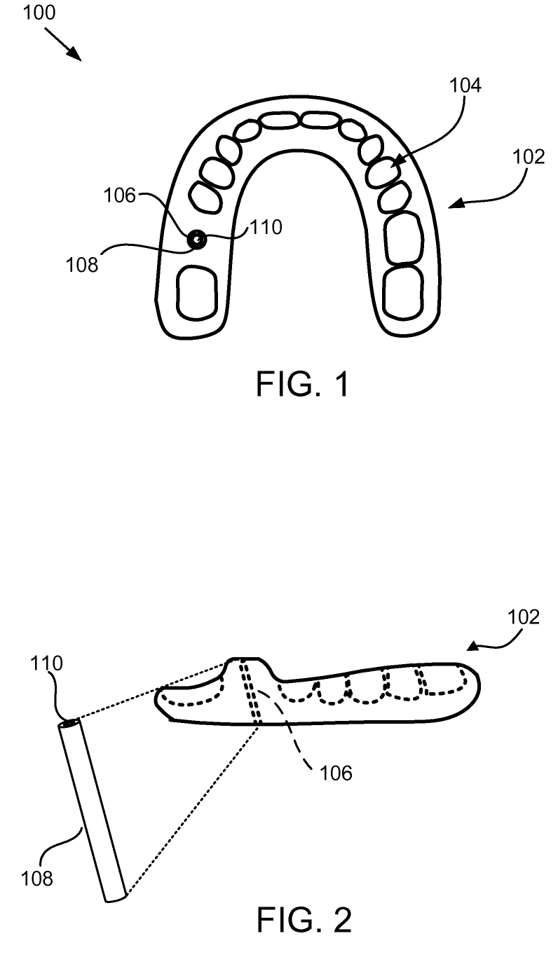

One representative embodiment of a dental implant system 100 is shown in FIGS. 1-8. The dental implant system 100 includes a guide splint 102 having an impression 104 of a patient's teeth and gums. In this manner, the guide splint 102 is adapted fit over a set of teeth of the patient, e.g., to mate with the teeth and gums of the patient. In other words, the teeth and gums of the patient are received in or mate with the impression 104 formed in the guide splint 102. In one implementation, the guide splint 102 is formed by introducing, such as by pouring, pressing, or otherwise exposing, a malleable material, such as a heated acrylic or plastic, over a cast of the patient's mouth. The malleable material is then allowed to harden over time. The cast of the patient's mouth, e.g., set of teeth, can be made using any of various casting techniques known in the art.

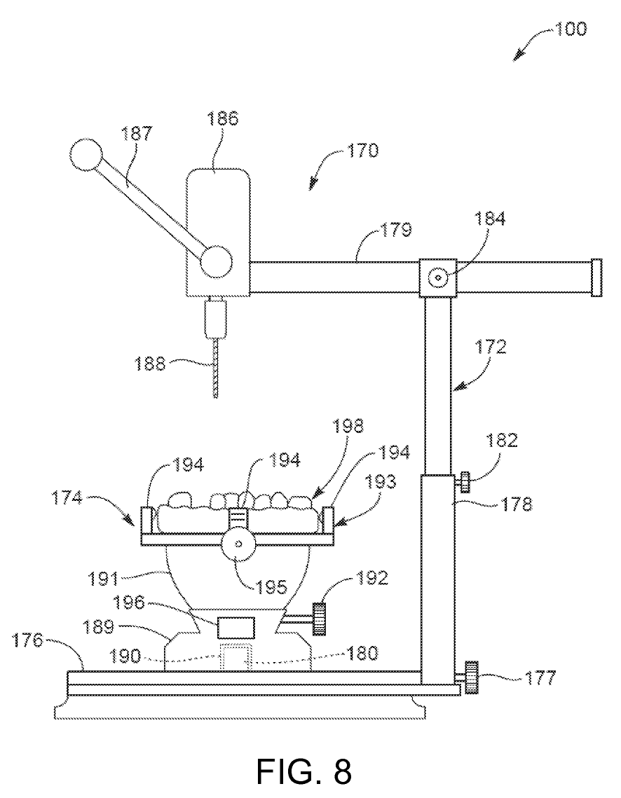

As shown in FIGS. 1 and 2, the guide splint 102 includes a guide hole 106 formed in the splint at a location or position corresponding with the desired location or position of a dental implant. Further, the orientation, e.g., angle or direction, of the guide hole 106 corresponds with the desired orientation of the dental implant. Generally, the guide hole 106 is formed by drilling a hole into the guide splint 102 using a drilling device, such as drilling assembly 170 described below in association with FIG. 8.

The guide splint 102 also includes at least one embedded guide sleeve 108. In some implementations, the guide sleeve 108 is embedded in the guide splint 102 by inserting the guide sleeve into the guide hole 106. The size of the guide hole 106 corresponds with the size of the guide sleeve 108. In this manner, when retained within the guide hole 106, the position and orientation of the guide sleeve 108 correspond with the desired position and orientation of the dental implant. The guide sleeve 108 is retained within the guide hole 106 via an adhesive, a press-fit connection, a thermal technique, or other technique known in the art. In some implementations, the guide sleeve 108 is permanently retained within the guide hole 106. In other implementations, as will be described in more detail below, the guide sleeve 108 is removably retained within the guide hole 106. Preferably, the guide sleeve 108 has a generally tubular shape. However, the guide sleeve 108 can have any of various shapes as desired. Further, the guide sleeve 108 can be made from any of various materials, such as plastic or metal.

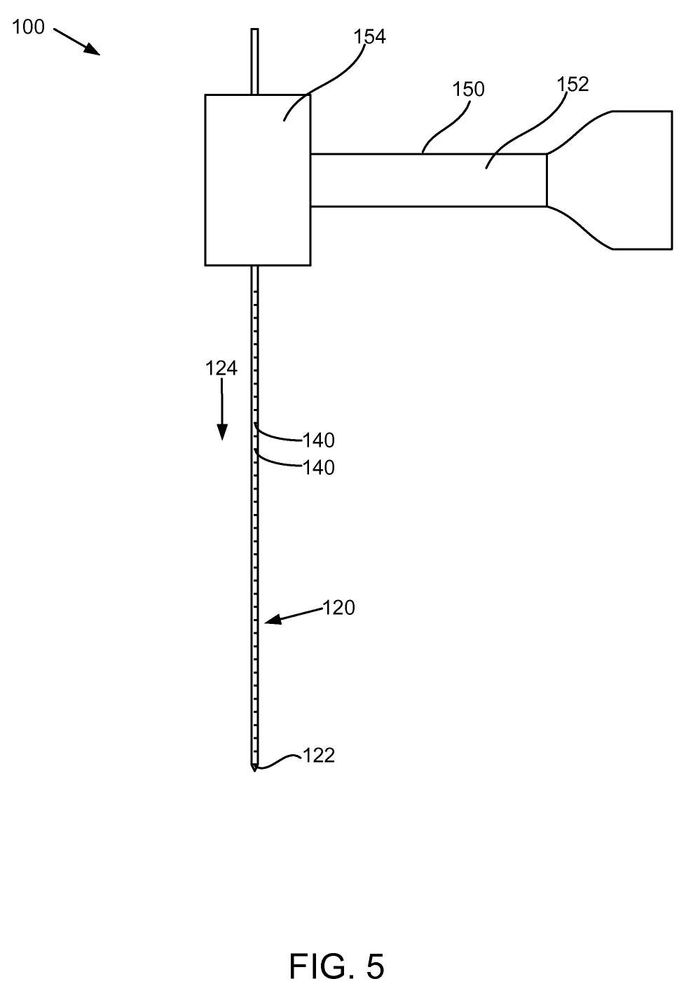

The guide sleeve 108 includes a guide channel 110 extending along a length of the guide sleeve. The guide channel 110 is sized and shaped to matingly receive a guide pin 120 (see FIG. 5). In the illustrated embodiment, the guide pin 120 is generally cylindrically shaped. Accordingly, the guide channel 110 in the illustrated embodiment is a generally cylindrically shaped channel extending coaxially along the length of the guide sleeve 108. However, in other embodiments, the guide pin 120 can have any of various other cross-sectional shapes, such as square, rectangular, triangular, and hexagonal, and the guide channel 110 can be an elongate channel defining a corresponding cross-sectional shape.

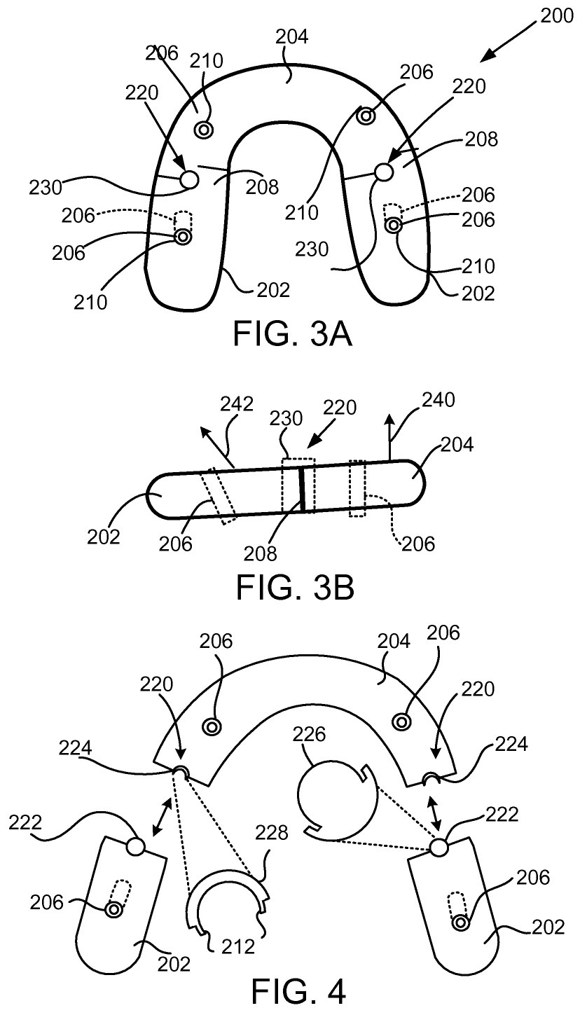

Referring to FIG. 3A, the system 100 can include a guide splint 200 similar to guide splint 102, but having two separable and connectable portions 202, 204, as well as multiple guide sleeves 206. As illustrated, the guide splint 200 is a splint used for installing denture implants. As such, the guide splint 200 includes only an impression of the patient's gums and does not include an impression of the patient's teeth as a patient being fitted for dentures typically does not have teeth. In alternative embodiments for installing non-denture implants, the guide splint 200 includes an impression of the patient's teeth. The portions 202, 204 are connectable along a cut 208 dividing the guide splint 200 into the three portions (i.e., a front portion 202 and two rear portions 204). Generally, the guide splint 200 can be used when multiple implants are being implanted at different angles, i.e., non-parallel orientations. For example, referring to FIG. 3B, the guide sleeves 206 in the front portion 202 are substantially vertically oriented and the guide sleeves 206 in the rear portions 204 are substantially diagonally oriented.

The portions 202, 204 are coupled to each other via one or more coupling or engagement mechanisms 220 configured to removably retain the portions 202, 204 against each other. Referring to FIG. 4, each engagement mechanism 220 includes a first portion 222 secured to one of the guide splint portions, e.g., a respective one of the rear portions 202, and a second portion 224 secured to the other of the guide splint portions, e.g., the front portion 204. The first portion 222 of the engagement mechanism 220 is engageable with the second portion 224 of the engagement mechanism to removably retain the two portions 202, 204 of the guide splint 200 together. Similarly, the first and second portions 222, 224 of the engagement mechanism 220 are disengageable with each other to separate the two portions 202, 204 of the guide splint 200.

The first and second portions 222, 224 of the engagement mechanisms 220 can be integrally formed in the splint guide 200 or secured to respective holes 230 formed in the splint guide 200 using an adhesive or bonding technique known in the art. As shown, the cut 208 extends through the holes 230 to split the holes into two portions. The first and second portions 222, 224 of each engagement mechanism 220 can have any of various configurations for facilitating a removable connection, such as a snap-fit connection. As one specific example, the engagement mechanisms 220 illustrated in FIG. 4 utilize a ball-in-socket or snap-fit approach for removably connecting the two portions 202, 204 of the guide splint 200. More specifically, the first portion 222 includes a circular male component 226 and the second portion 224 includes a semi-annular female component 228 configured to matingly receive the male component 226. At least one of the male and female components 226, 228 includes a resiliently flexible portion configured to flex under pressure from the opposing component. For example, the female component 228 includes resiliently flexible end portions 212 that flex outwardly when contacted by the male component 226 with sufficient force. A maximum distance between the flexible end portions 212 is less than the diameter of the male component 226.

As the male component 226 is inserted into the female component 228 with a force greater than a biasing force of the flexible end portions 212, the flexible end portions flex outwardly from an unbiased state into a biased state until half of the male component 226 is beyond the end portions, at which time the end portions are resiliently biased to return to an unflexed state. In this manner, the male component 226 is snap-fit together with the female component 228. In the unflexed state, the female component 228 wraps around a portion of the male component greater than one half of its circumference such that the male component 226 is retained within the female component 228 and the first portion 202 of the guide splint 200 is secured to the second portion 204 to effectively form one piece. When separation of the guide splint 200 is desired, the male component 226 can be pulled against the flexible end portions 212 of the female component 228 with a force greater than the biasing force of the flexible end portions 212 such that the end portions flex to allow the male component 226 to be removed from engagement with the female component 228.

Although the guide splint 200 includes two separable portions 202, 204 with two engagement mechanisms 220, in other embodiments, a guide splint with separable portions can include three or more separable portions with one or more than two engagement mechanisms as desired.

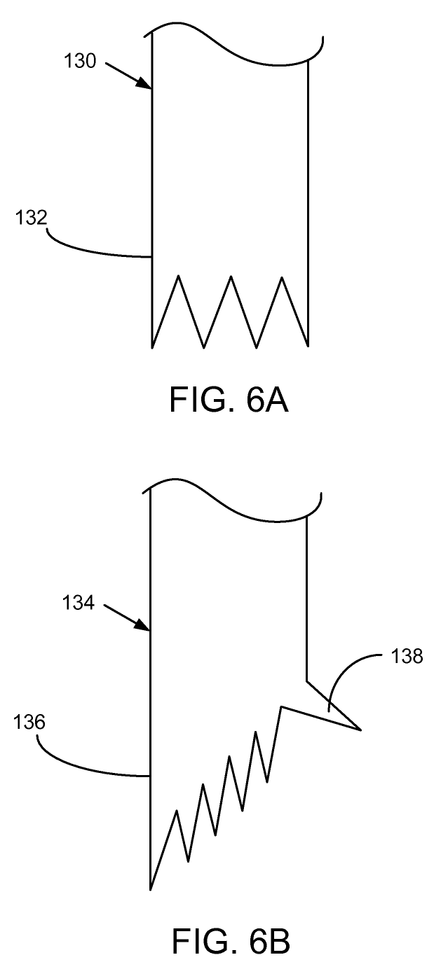

Referring to FIG. 5, the guide pin or wire 120 includes a thin elongate length of an at least partially rigid material, such as metal. The material can be formed in a substantially cylindrical shape as shown, or in any of various other shapes as desired. The guide pin can have any of various width-to-length ratios substantially less than one. In certain implementations, the guide pin 120 has a width of approximately 0.5 mm and a length between approximately 15 mm and approximately 25 mm. In one implementation, the guide pin 120 is sized to fit a 2.0 mm drill. The guide pin 120 includes a bone penetrating end portion 122 configured to penetrate bone tissue and anchor the guide pin to the bone tissue. The bone penetrating end portion 122 can converge into a single sharp point as shown in FIG. 3. In other embodiments, the guide pin includes a jagged edge with several sharp points or teeth for facilitating penetration into and a secure attachment to the bone tissue. For example, as shown in FIG. 6A, a guide pin 130 includes a bone penetrating end portion 132 having a series of sharp teeth each extending from a flat end of the guide pin.

Alternatively, as shown in FIG. 6B, a guide pin 134 includes a bone penetrating end portion 136 having a series of sharp teeth each extending from an angled end of the guide wire. The angled configuration of the bone penetrating end portion 136 promotes penetration of the guide pin 134 into and secure attachment of the guide pin to relatively steeply angled bone tissue. The sharp teeth can each extend away from the end of the guide pin in a generally lengthwise direction relative to the guide pin as is indicated by direction arrow 124. However, one or more of the sharp teeth can extend away from the end of the guide pin in a direction angled with respect to the lengthwise direction of the guide pin. For example, bone penetrating end portion 136 includes an angled tooth 138 extending away from the end of the guide pin in a direction forming an angle greater than zero and less than ninety with respect to the lengthwise direction. The angled tooth 138 may provide more penetration into steeply angled bone tissue than non-angled teeth to more firmly anchor the guide pin 134 to the bone.

In certain embodiments, the guide pin 120 includes indicia 140 of depth along a length of the guide pin. As will be described in more detail, the indicia 140 are used to determine how far the guide pin has penetrated the bone tissue and deep a drill bit has penetrated the bone tissue, e.g., the depth of the drilled hole. The indicia 140 can be markings spaced an equal distance, e.g., 1 mm, apart from each other along a length of the guide pin 120 beginning at an end of the bone penetrating portion 122. Each mark can indicate numerically the distance away from the end of the bone penetrating portion 122. The indicia 140 can be formed in or placed on the outer surface of the guide pin 120 using any of various techniques known in the art, such as etching, printing, laminating, and cutting.

The guide pin 120 has relatively smooth sides and is configured to be driven into bone tissue without the need for rotation. Accordingly, penetration of the guide pin 120 does not tear or damage surrounding gingival tissue. Referring to FIG. 5, the dental implant system 100 includes a guide pin driver 140 for driving the guide pin into bone tissue. The guide pin driver 150 includes a handle portion 152 coupled to a driving portion 154. The handle portion 152 can be configured to attach to a standard E-type implant motor and the driving portion 154 can include a friction grip, such as contained in K-wire drivers commonly known in the art. The driving portion 154 rotates the guide pin 120 by actuating the friction grip. As the guide pin 120 is rotating, the practitioner drives the guide pin 120 into the bone by grasping and pushing against the handle portion 152. Rotation of the guide pin 120 facilitates insertion of the guide pin into the bone. As the driving portion 154 nears or comes in contact with the bone during the guide pin 120 insertion process, rotation of the guide pin 120 can be halted and the friction grip can be released. This allows the practitioner to slide the driving portion 154 up the guide pin, re-secure the friction grip to the guide pin, and continue with the insertion process without impedance from the driving portion.

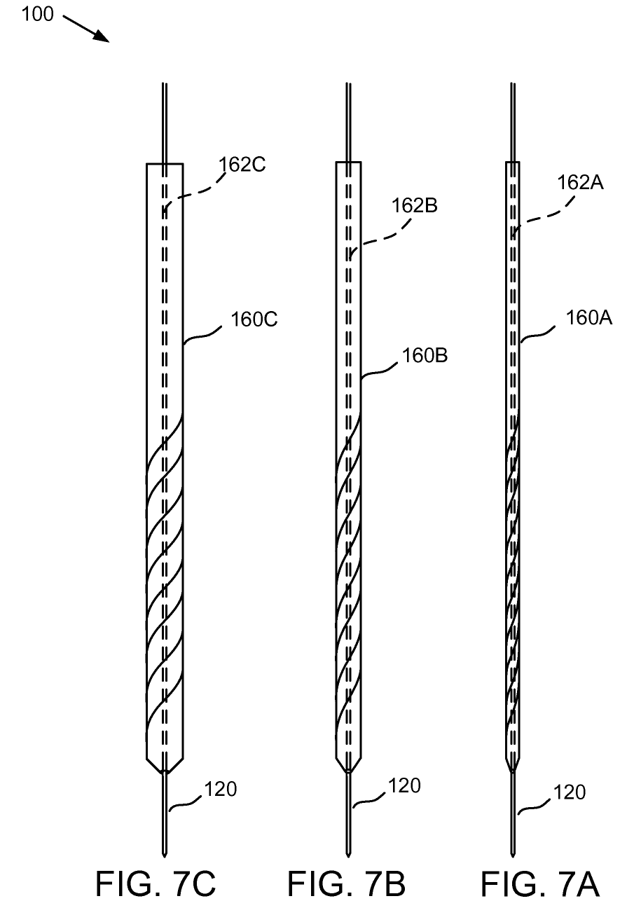

Referring to FIGS. 7A-7C, the dental implant system 100 includes two or more cannulated drill bits, such as drill bits 160A-160C, each sized to drill a differently sized cylindrical hole in bone tissue. As illustrated, drill bit 160A of FIG. 7A is smaller, i.e., has a smaller outer diameter, than drill bit 160B of FIG. 7B and drill bit 160B is smaller than drill bit 160C of FIG. 7C. Accordingly, drill bit 160A is configured to form a cylindrical hole smaller than a hole formed by drill bit 160C, and drill bit 160B is configured to form a cylindrical hole smaller than a hole formed by drill bit 160C. Generally, the diameter of the holes formed by the drill bits corresponds with the outer diameter of the respective drill bits. The drill bits can have straight or tapered shanks, and have any of various spirals, point angles, and lip angles appropriate for drilling bone tissue.

Each drill bit 160A-160C includes a respective channel 162A-162C through which the guide pin 120 is extendable. The channels 162A-162C extend coaxially along the entire length of the respective drill bits 160A-160C. When extended through the channels 162A-162C, the guide pin 120 is configured to guide the drill bits 160A-160C in a direction parallel to the lengthwise direction 124 of the guide pin. Accordingly, the cross-sectional areas of the channels 162A-162C closely match the cross-sectional area of the guide pin 120. For example, the diameters of the channels 162A-162C are just larger than the diameter of the guide pin 120. In this manner, when the guide pin 120 is extended through the channels 162A-162C, the axes of the drill bits 160A-160C are substantially coaxial with the axis of the guide pin 120. Maintaining coaxial alignment of the drill bits 160A-160C with a guide pin 120 anchored to bone tissue ensures the drill bits enter the bone tissue at the same orientation as the guide pin and at a desired location.

As shown in FIG. 8, the dental implant system 100 includes a drilling apparatus 170 or splint formation device configured to facilitate precise positioning and orientation of the guide sleeve 108 in the splint 102. The drilling apparatus 170 includes a drill press 172 removably coupled to an alignment stand 174.

The drill press 172 includes a base 176 and a vertical arm 178 pivotable about the base 176. The vertical arm 178 includes a telescoping member adjustable to change the height of the vertical arm. When the vertical arm 178 is adjusted to a desired angle with respect to the base 176 and the height of the vertical arm 178 is adjusted to a desired height, the locks 177, 182 can be tightened to secure the vertical arm at the desired angle and height, respectively. The drill press 172 also includes a horizontal arm 179 coupled to a drill bit driving assembly 186. The horizontal arm 179 is adjustable horizontally to move the driving assembly 186 toward and away from the vertical arm 178. When the drill bit driving assembly 186 is in a desired location with respect to the base 176, the horizontal arm 179 can be locked into place via a lock 184. The drill bit driving assembly 186 includes a drill bit chuck for securing a drill bit, such as drill bit 188. The drill bit 188 can be raised and lowered relative to the drill bit driving assembly 186 via actuation of a handle 187. In some implementations, the horizontal arm 179 includes markings indicating a distance between the axis of the drill bit 188 and an origin, e.g., geometric center, of the base 176. The drill press 172 includes a locking key 180 protruding from and fixed relative to the base 176. In certain implementations, the locking key 180 is positioned at the origin of the base 176.

The alignment stand 174 includes a base 189 having a notch 190 formed therein. The notch 190 is configured to matingly engage the key 180 of the drill press 172 to removably secure the alignment stand 174 in a predetermined position and orientation relative to the base 176. In certain implementations, the notch 190 is matingly engaged with the key 180 by sliding the notch over the key. In this manner, the position and orientation of the alignment stand 174 relative to the base 176 can be reliably reproduced during the guide sleeve forming process. The base 189 pivotally receives a ball-shaped, e.g., semi-spherically-shaped, component 191. The alignment stand 174 includes a clamp 193 secured to the ball-shaped component 191 that is movable, e.g., pivotably relative to the base 189. The clamp 193 includes at least three adjustable arms 194 for securing a cast, such as cast 198. The arms 194 can be tightened against and loosened from the cast by rotating the adjustment knob 195. The orientation of the ball-shaped component 191, and thus the orientation of the clamp 193 and a cast secured to the clamp, is adjustable into any of an infinite number of orientations by rotating or pivoting the component 191 relative to the base 189. When the orientation of the cast or splint is in a desired orientation, a lock 192 can be tightened to fix the ball-shaped component 191 relative to the base 189. To facilitate a precise and proper orientation of the cast or splint, the alignment stand 174 can include orientation indicia 196, such as a digital readout, indicating of the orientation of the cast or splint.

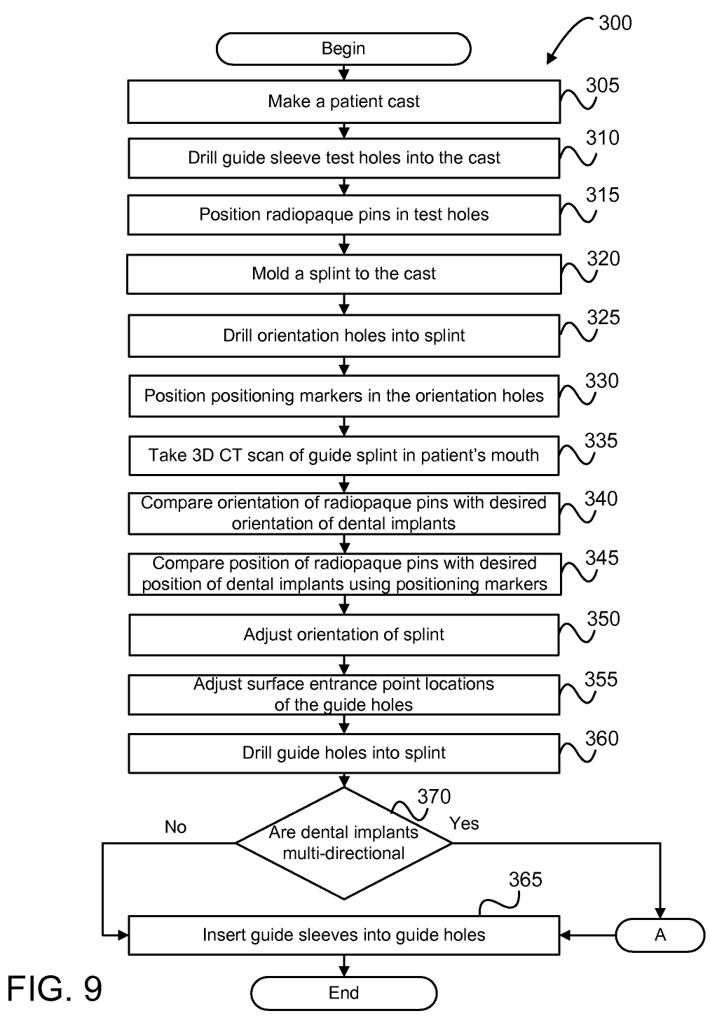

Referring to FIG. 9, a method 300 is shown for forming a guide splint, such as guide splints 102, 200. The method 300 begins by making 305 a cast, e.g., cast 198 of FIG. 8, of the patient's mouth and drilling 310 guide sleeve test holes into the cast at the same location and orientation as the desired location and orientation of the implants using the drilling assembly 100. More specifically, in one example, the cast is secured in the clamp 193 of the alignment stand 174 and the position of the clamp is adjusted into the desired orientation of the dental implant using the ball-shaped component 191. The orientation of the clamp 193 is secured in place by tightening the lock 192. The position of the drill bit driving assembly 186 is then adjusted to place the drill bit 188 in the desired position of the dental implant. Adjustment of the drill bit driving assembly 186 position can be effectuated by rotation of the vertical arm 178 and movement of the horizontal arm 179. With the desired position and orientation of the cast locked into place, the test hole can be drilled into the cast using the handle 187 to lower the drill bit 188 into the cast.

After a desired number of guide sleeve test holes are drilled into the cast, pins made from a radiopaque material, such as metal or plastic, are positioned 315 in the test holes such that a portion of the pins extend above the surface of the cast. The alignment stand 174 is then removed from the drill press 172 with the cast still secured to the stand or the alignment stand can remain coupled to the drill press. The method 300 then includes molding 320 a splint over the cast and pins by pouring or pressing a malleable and hardenable material, such as heated acrylic, onto the cast. The pins are molded into or integrated with the molded splint. After the malleable material hardens, if the alignment stand 174 has been removed for the guide splint molding process, the stand is again secured to the drill press 172 by engaging the notch 190 with the key 180. Orientation holes are then drilled 325 into the splint 102 and radiopaque positioning markers or pins are positioned 330 in the orientation holes. In certain implementations, three orientation holes are drilled 325 into the splint. The three orientation holes include two x-axis holes positioned on approximately opposite sides of the origin of the drill press 172 on an x-axis associated with the origin. The third of the three orientation holes is a y-axis hole positioned on a y-axis associated with the origin. Each of the orientation holes is parallel to each other.

The method 300 includes removing the splint from the cast with the radiopaque markers molded to the splint 102, trimming the radiopaque pins if necessary, placing the splint in the patient's mouth, and taking 335 a medical imaging scan, e.g., a 3D CT scan, of the guide splint in the patient's mouth. In certain implementations, the desired orientation, position, and depth of each dental implant is determined using implant placement software commonly known in the art. Using the 3D CT scan and imaging software, the angulation or orientation of the radiopaque markers are compared 340 with the desired orientation of the implants determined using the implant placement software. Similarly, using the position of the positioning markers shown in the 3D CT scan, the desired position or surface entrance point location of the dental implants are compared 345 with the actual position of the markers. Any discrepancies between the desired orientation of the dental implants and the actual orientation and position of the radiopaque markers are accounted for by adjusting 350 the orientation of the clamp 193. The actual surface entrance point location of the guide hole 106 may also be adjusted 350 based on the comparison 345 between the actual marker position as recorded on a grid of the 3D CT scan and the desired dental implant positions selected using the positioning software by marking the cast 198 using a coordinate system grid sheet. The grid sheet is a clear plastic template with an x-axis and y-axis coordinate grid printed or formed thereon and small holes at each corner of the squares forming the grid. The grid sheet is positioned on the cast 198 (which is secured in the clamp 193 at the desired orientation) such that the x-axis and y-axis of the template is aligned with the orientation holes such that the template effectively mimics the grid of the CT scan. A marking tool can then be inserted into the hole in the grid sheet corresponding to the corrected implant position or entrance site. After the drill bit driving assembly 186 is securely positioned over the corrected entrance site, the guide splint 102 is placed on the cast 198 and the drill bit driving assembly 186 is actuated to drill a hole into the splint at the corrected entrance site.

After the orientation of the clamp 193 is properly adjusted and the surface entrance point location is properly marked for a respective guide hole 106, the method 300 includes drilling 360 guide hole 106 at the adjusted orientation and marked location to a desired depth. In this same manner, a guide hole 106 corresponding to each dental implant is drilled 360. A guide sleeve 108 is then inserted 365 into each guide hole 106.

In an alternative method for forming a guide splint, the method includes only actions 305, 320, 360 and 365 of method 300. In other words, in certain methods, the splint 102 can be formed without using 3D imaging techniques.

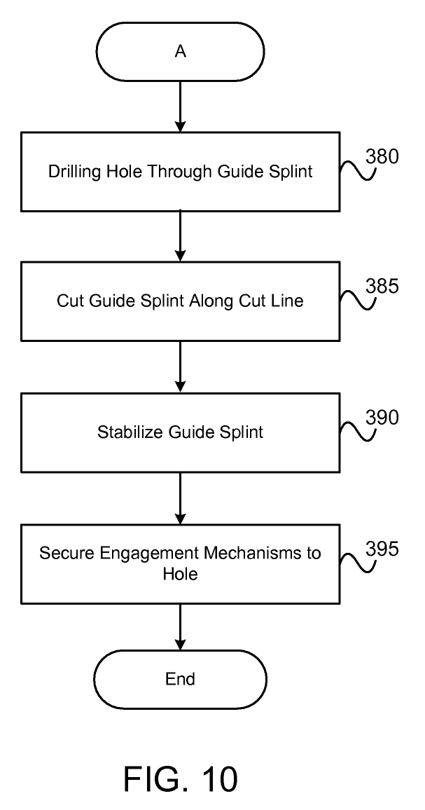

For situations involving multiple dental implants at multiple orientations, the method 300 can include actions for forming a multidirectional guide splint, such as guide splint 200. If there are no multidirectional dental implants as determined in action 370, then the method 300 proceeds from action 360 to action 365. However, if there are multidirectional dental implants as determined in action 370, the method 300 proceeds to actions associated with method actions 375 (see FIG. 10). With reference to guide splint 200, the subroutine A includes drilling 380 at least one hole 230 through the guide splint. The subroutine A then includes cutting 385 the splint 200 into the at least two portions 202, 204 along the cut line extending through the holes 230. In some embodiments, the cut is configured to extend through the guide holes 206 drilled in the splint. The cut line can be straight as illustrated or curved as desired. After being cut, the splint 200 can be stabilized 390 or temporarily kept together using any of various stabilizing means, such as wax or through use of a clamp. An engagement mechanism, such as mechanisms 220, is then positioned and secured 395 within the holes 230 using any of various techniques, such as placing an adhesive between the mechanisms and the surfaces of the holes 230.

After the guide splint 102, 200 is formed, it can be used to accurately and precisely implant dental implants in a patient's mouth. According to one embodiment, a method 400 for implanting one or more dental implants includes properly placing 405 the guide splint 102, 200 in the patient's mouth over the patient's teeth and gums. The method 400 proceeds by determining 410 whether a cannulated technique or non-cannulated technique is desirable. If a cannulated technique is desired, the method 400 includes driving 415 a guide pin 120 through the channels of each of the guide sleeves 108 and into the bone tissue using the guide pin driver 150. The method 400 then determines whether there are multiple multidirectional dental implants at 420. If there is only a single dental implant or multiple generally parallel dental implants, then the method 400 proceeds to remove 425 the guide splint 102 from the patient's mouth by simultaneously sliding the entire guide splint and guide sleeve(s) along the guide pin(s) away from the implant location(s).

If, however, there are multiple multidirectional dental implants as determined at 420, then the method determines 430 whether the multidirectionality of the dental implants is excessive, e.g., forming at angle of greater than 10 degrees. If the multidirectionality of the dental implants is not excessive, then the guide splint is removed by first removing 435 one or more of the guide sleeves from the guide splint and sliding the guide sleeves along the guide pins away from the guide splint. In this manner, space is created between the guide pins and the respective guide holes, which provides additional maneuverability and lateral freedom for then removing 440 the guide splint from engagement with the guide pins and the patient's mouth. If, however, the multidirectionality of the dental implants is excessive, then the guide splint, e.g., guide splint 200, is removed by separating 445 the guide splint into two or more pieces or portions (e.g., portions 202, 204 of guide splint 200). The portions are then separately removed 450 from the patient's mouth by individually sliding each portion and associated guide sleeve(s) along the associated guide pin(s) away from the implant location(s). In one embodiment, the portion of the guide splint housing the least angled sleeve(s) (e.g., front portion 204 housing vertical sleeves 206) is first removed in a direction away from the patient's gums and parallel to the orientation of the least angled sleeve(s), such as shown by directional arrow 240 in FIG. 3B. Then, the portion or portions housing the more severely angled sleeves (e.g., rear portions 202 housing respective sleeve 206) are subsequently removed in a direction away from the patient's gums and parallel to the orientation of the angled sleeve(s), such as shown by directional arrow 242 in FIG. 3B. Separating the guide splint into one or more portions can provide greater maneuverability and lateral freedom for removing the guide splint from engagement with the guide pins compared with removing just the guide sleeves. In one embodiment, the portions of the guide splint are separated by disengaging engagement elements, e.g., engagement mechanisms 220, that retain the portions together.

After the splint guide has been removed from the patient's mouth following one of the actions 425, 440, 450, the method 400 proceeds to subroutine B. In subroutine B, a first cannulated drill bit, e.g., drill bit 160A, is slid onto the guide pin anchored to the bone tissue and actuated to drill 500 a first hole in the bone tissue. The first hole has a first diameter corresponding to the size of the first cannulated drill bit. The drill bit 160A penetrates the bone tissue to a depth equal to the desired depth of the dental implant. Further, the guide pin guides and stabilizes the drill bit as it drills the first hole. In this manner, the guide pin facilitates the drilling of a hole substantially at a desired position and orientation of the dental implant. After the first hole is drilled 500, the first cannulated drill bit is removed, e.g., slid off of the guide pin, and a second cannulated drill bit, e.g., drill bit 160B, is slid onto the guide pin to drill 510 a second hole in the bone tissue over the first hole. The second cannulated drill bit is larger than the first cannulated drill bit such that the second hole has a larger diameter than the first hole, thus effectively enlarging the resultant hole in the bone tissue. The guide pin guides and stabilizes the second cannulated drill bit such that the second hole is also substantially in the desired position and orientation of the implant. After the second hole is drilled 510, the second cannulated drill bit is removed and a third cannulated drill bit, e.g., drill bit 160C, is slid onto the guide pin to drill 520 a third hole in the bone tissue over the second hole. The third cannulated drill bit is larger than the second cannulated drill bit such that the third hole has a larger diameter than the second hole, thus effectively enlarging the resultant hole in the bone tissue. The guide pin guides and stabilizes the third cannulated drill bit such that the third hole is also substantially in the desired position and orientation of the implant. The third cannulated drill bit is then removed.

The general actions associated with events 510-520 can be repeated, but with incrementally larger cannulated drill bits, until the hole in the bone tissue reaches a desired diameter for implanting the dental implant. Incrementally or gradually increasing the size of the drill bits promotes cleaner and more precise holes, as well as reduces inadvertent chipping of the bone tissue and removal of other tissue adjacent the implant site. After the implant hole reaches the desired diameter, the guide pin anchored in the bone tissue is removed 540. In certain implementations, the guide pin is removed 540 using removal tool, such as a reverse friction grip removal tool. If necessary, the removal tool can be coupled to a ratcheting mechanism for facilitating removal of the guide pin. It is noted that although a method using several incrementally larger cannulated drill bits is shown and provides certain advantages, in other embodiments, a single cannulated drill bit corresponding to the desired diameter for implanting the dental implant can be used.

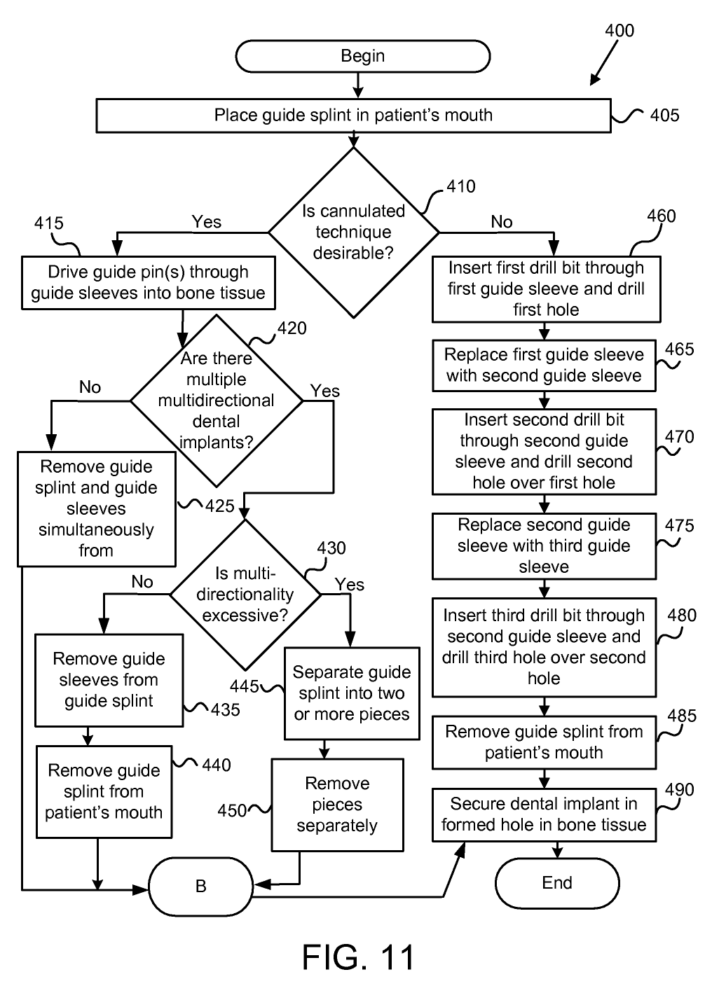

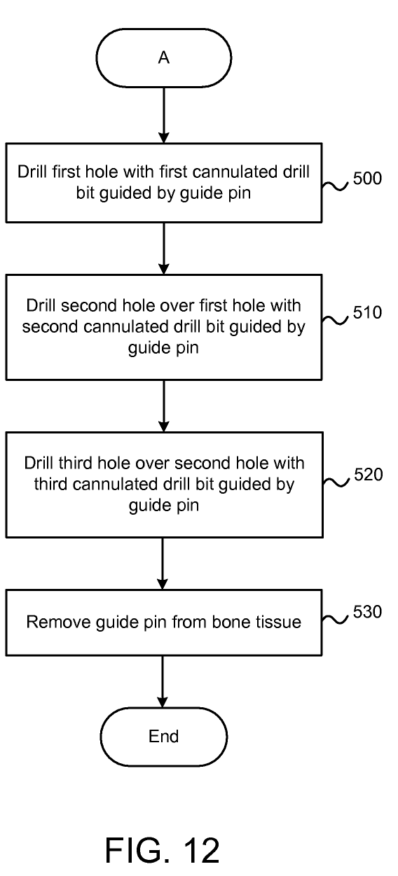

Referring back to FIG. 11, if a cannulated technique is not desirable as determined at action 410, the method 400 proceeds to insert 460 a first drill bit through the first guide sleeve in the guide splint and drill a first hole in the bone tissue. The first drill bit has an outer diameter that closely fits the inside diameter of the guide channel defined by the first guide sleeve. In this manner, the guide sleeve acts to guide and stabilize the first drill bit such that the first hole is substantially in the desired position and orientation of the implant.

After the first hole is drilled, the first drill bit is pulled out of the first guide sleeve. The first guide sleeve is then removed and replaced 465 by a second guide sleeve having a guide channel larger than the guide channel of the first guide sleeve, but an outer diameter the same as the outer diameter of the first guide sleeve. A second drill bit larger than the first drill bit is inserted 470 through the guide channel of the second guide sleeve to drill a second hole over the first hole. The second hole is larger than the first hole such that the first hole is effectively enlarged by the drilling of the second hold. The second drill bit has an outer diameter that closely fits the inside diameter of the guide channel defined by the second guide sleeve. In this manner, the guide sleeve acts to guide and stabilize the second drill bit such that the second hole is substantially in the desired position and orientation of the implant.

After the second hole is drilled, the second drill bit is pulled out of the second guide sleeve. The second guide sleeve is then removed and replaced 475 by a third guide sleeve having a guide channel larger than the guide channel of the second guide sleeve, but an outer diameter the same as the outer diameter of the first and second guide sleeves. A third drill bit larger than the second drill bit is inserted 480 through the guide channel of the third guide sleeve to drill a third hole over the second hole. The third hole is larger than the second hole such that the second hole is effectively enlarged by the drilling of the third hold. The third drill bit has an outer diameter that closely fits the inside diameter of the guide channel defined by the third guide sleeve. In this manner, the guide sleeve acts to guide and stabilize the third drill bit such that the third hole is substantially in the desired position and orientation of the implant. Although the drill bits utilized in actions 460-480 can be cannulated drill bits, because a guide pin is not used to guide and stabilize the drill bits, non-cannulated drill bits can be used.

The general actions associated with actions 460-480 can be repeated, but with guide sleeves having incrementally larger guide channels and incrementally larger drill bits, until the hole in the bone tissue reaches a desired diameter for implanting the dental implant. After the implant hole reaches the desired diameter, the guide splint is removed 485 from the patient's mouth.

With the guide pin removed from the patient's mouth in action 530 or the guide splint removed from the patient's mouth in action 485, a dental implant can be positioned within the resultant hole formed in the bone tissue and secured 490 therein using any of various dental implantation techniques known in the art, such as cementation or other bonding techniques.

The cannulated drill bit system and associated method described herein have certain advantages over non-cannulated drill bit systems and methods. For example, in some embodiments, a practitioner using a non-cannulated drill bit method, e.g., using sleeves in a splint to guide a drill bit as it drills a hole in the bone, may have difficultly viewing the bone during drilling. More specifically, the guide sleeves may block the practitioner's view of the bone as it is being cut. In contrast, because the drill bits of the cannulated drill bit system described herein fit over a guide pin, the practitioner is able to maintain a clear view of the bone being cut throughout the drilling procedure.

The schematic flow chart diagrams herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A cannulated dental implant system for implanting a dental implant in bone tissue, comprising:
a guide splint comprising at least one guide sleeve defining a guide channel;
a guide pin comprising a bone penetrating end portion, the guide pin being extendable through the guide channel and drivable into bone tissue;
a first drill bit comprising a first outer diameter and an axial channel sized to receive the guide pin, the first drill bit being rotatable about the guide pin to drill a hole into the bone tissue, the hole have a diameter corresponding with the first outer diameter;
a second drill bit comprising a second outer diameter greater than the first outer diameter, the second drill bit further comprising an axial channel sized to receive the guide pin, wherein the second drill bit is rotatable about the guide pin to enlarge the hole in the bone tissue to correspond with the second outer diameter; and
a dental implant securable within the enlarged hole.

2. The cannulated dental implant system of claim 1, wherein the guide splint comprises a plurality of guide sleeves.

3. The cannulated dental implant system of claim 2, wherein at least two of the plurality of guide sleeves are oriented at different angles with respect to each other.

4. The cannulated dental implant system of claim 1, wherein the at least one guide sleeve is removably secured to the guide splint.

5. The cannulated dental implant system of claim 1, wherein the at least one guide sleeve is positioned within a hole formed in the guide splint.

6. The cannulated dental implant system of claim 1, wherein the guide splint comprises at least two separable interconnected portions.

7. The cannulated dental implant system of claim 6, wherein the at least two separable interconnected portions are separable along a cut coextensive with a line extending through at least one guide sleeve.

8. The cannulated dental implant system of claim 6, wherein the at least two separable interconnected portions comprises at least first and second portions, the first portion comprising at least one first engagement element and the second portion comprising at least one second engagement element corresponding with the first engagement element, wherein the first and second engagement elements are engageable to couple the first and second portions together and disengageable to separate the first and second portions from each other.

9. The cannulated dental implant system of claim 8, wherein the first engagement element comprises an at least partially circular element and the second engagement element comprises an at least partially flexible socket configured to removably retain the at least partially circular element.

10. The cannulated dental implant system of claim 1, wherein the guide pin comprises a series of markings indicating a depth of the guide pin in the bone tissue.

11. The cannulated dental implant system of claim 1, further comprising a drilling assembly comprising a guide splint orientation adjustment stand removably coupled to a drill press.

12. The cannulated dental implant system of claim 11, wherein the drill press comprises a first mating feature, the guide splint orientation adjustment stand comprises a second mating feature matingly engageable with the first mating feature to removably secure the guide splint orientation adjustment stand in a desired position relative to the drill press.

13. The cannulated dental implant system of claim 11, wherein the guide splint orientation adjustment stand is pivotable to orient a guide splint secured to the orientation adjustment stand in any of an infinite number of 3-dimensional orientations.

14. A method for implanting dental implants in bone tissue, comprising:
making a dental splint comprising at least one sleeve at a location corresponding with a desired implant location;
positioning the dental splint over a set of teeth;
driving a guide pin through the at least one sleeve and into bone tissue;
removing the dental splint from the set of teeth;
engaging a first drill bit with the guide pin and drilling a hole in the bone tissue with the first drill bit while engaged with the guide pin;
engaging a second drill bit with the guide pin and expanding the hole in the bone tissue with the second drill bit while engaged with the guide pin;
removing the guide pin from the bone tissue; and
positioning a dental implant in the expanded hole in the bone tissue.

15. The method of claim 14, wherein removing the dental splint from the set of teeth comprises separating the dental splint into at least two pieces and individually removing the two pieces from the set of teeth.

16. The method of claim 15, wherein separating the dental splint into at least two pieces comprises disengaging corresponding engagement elements each coupled to a respective one of the two pieces.

17. The method of claim 14, wherein removing the dental splint from the set of teeth comprises removing the at least one sleeve from the guide splint then removing the dental splint without the at least one sleeve from the set of teeth.

18. The method of claim 14, wherein making the dental splint comprises drilling a hole in the splint and positioning the at least one sleeve in the splint hole.

19. The method of claim 14, wherein making the dental splint comprises:
making a cast of the set of teeth;
drilling at least one hole in the cast at the location corresponding with the desired implant location;
positioning a radiopaque marker in the at least one hole;
forming the dental splint over the cast and radiopaque marker, the radiopaque marker being secured within the dental splint;
placing the dental splint with radiopaque marker over the set of teeth and imaging the dental splint and set of teeth;
comparing the location and orientation of the radiopaque marker with a desired location and orientation of the dental implant; and
drilling a hole in the splint based on the comparison between the location and orientation of the radiopaque marker and the desired location and orientation of the dental implant.

20. The method of claim 14, wherein the dental splint comprises a plurality of sleeves, and driving a guide pin comprises driving a plurality of drive pins through respective sleeves of the plurality of sleeves.

21. A dental implant system for implanting a dental implant in bone tissue, comprising:
a plurality of guide sleeves each defining a differently sized guide channel;
a guide splint positionable over a set of teeth, the guide splint comprising a hole configured to individually receive each of the plurality of guide sleeves; and
a plurality of drill bits each differently sized to correspond with a respective one of the differently sized guide channels of the plurality of guide sleeves;
wherein each of the plurality of drill bits is configured to extend through the corresponding respective guide channel to form a hole in bone tissue.

22. A method for implanting dental implants in bone tissue, comprising:
making a dental splint comprising a hole at a location corresponding with a desired implant location and in an orientation corresponding with a desired implant orientation, wherein the hole is formed using a medical imaging process;
positioning the dental splint over a set of teeth;
inserting a first guide sleeve defining a first guide channel having a first dimension into the dental splint hole;
extending a first drill bit having a first outer diameter corresponding with the first dimension through the first guide channel of the first guide sleeve and drilling a first hole in the bone tissue, the first hole having a size corresponding with the first outer diameter;
removing the first guide sleeve from the dental splint hole and inserting a second guide sleeve defining a second guide channel having a second dimension into the dental splint hole, the second dimension being larger than the first dimension;
extending a second drill bit having a second outer diameter corresponding with the second dimension through the second guide channel of the second guide sleeve and drilling a second hole in the bone tissue in place of the first hole, the second hole having a size corresponding with the second outer diameter;
removing the dental splint from the set of teeth; and
positioning a dental implant in the second hole.
